(19) United States
(12) Patent Application Publication
(10) Pub. No.: US 2008/0301355 A1
(43) Pub. Date: Dec. 4, 2008

(54) FLASH MEMORY INFORMATION READING/WRITING METHOD AND STORAGE DEVICE USING THE SAME

(75) Inventors: Chih-Ling Wang, Hsinchu (TW); Wee-Kuan Gan, Hsinchu (TW)

Correspondence Address: J C PATENTS, INC., 4 VENTURE, SUITE 250, IRVINE, CA, 92618, US

(73) Assignee: PHISON ELECTRONICS CORP., Hsinchu (TW)

(21) Appl. No.: 11/755,210

(22) Filed: May 30, 2007

(51) Int. Cl. G06F 12/00; G06F 13/14

(52) U.S. Cl. 711/103; 710/305; 711/E12.078

(57) ABSTRACT

A flash memory information read/write method in which an external resource such as host, external memory, EEPROM, or external controller is used to read and update new flash memory information after fabrication of a flash memory device, enabling the new flash memory information to be written in a predetermined address in a flash memory module of the flash device by a controller of the flash memory device, so that every flash memory device that has an erroneous or damaged factory data or information is still usable, and the flash memory controller provider needs not to continuously develop new firmware controllers for different flash memories.

### BACKGROUND OF THE INVENTION

1. Field of the Invention

The present invention generally relates to a flash memory device. More particularly, the present invention relates to a flash memory information reading/writing method and storage device using the same, which allows to read a new flash memory information from external host or memory and to write the read flash memory information in a predetermined address in a flash memory module of the flash memory device by means of a controller of the flash memory device so that when the default manufacture data of the flash memory device is damaged, the flash memory device is still usable.

2. Description of Related Art

Following fast development of flash memory technology in recent years, high-capacity flash memories have been continuously created for use in different mobile electronic products such as MP3 players, PDAs, digital cameras, digital video cameras, and etc. Further, a video player generally has at least one control chip and a flash memory installed therein. The flash memory of a video player is for digital video decoding and recording application, and download of video data by a computer. There are commercial data storage devices using a flash memory. These data storage devices allow a computer user to extend the data storage capacity of the computer, and can be freely attached to a computer for data access. For the advantage of high convenience and compatibility to different electronic devices, flash memory has been widely accepted by consumers since its invention, and become one of the requisite implements of many people.

However, different flash memories of different types and sizes from different providers may be used for different applications. A flash memory has factory defaults indicating the memory block size, capacity, chip number, device code, and manufacturer's code, and a firmware engineer determines the type of a flash memory subject to its factory defaults. Further, the control program of a flash memory must determine the memory capacity or memory block size before reading or writing data. However, when this information is in error or not readable, the flash memory becomes unusable. Therefore, the flash memory information of a flash memory is quite important to a firmware engineer and flash memory manufacturer.

When running a flash memory control program, the program is started to use the command of, for example, READ ID to read the fabrication defaults. If the ID code of the flash memory does not match the default value in the controller, the controller will be unable to make an accurate data access action in the flash memory. It is quite important to flash memory manufacturers to find a way that avoids change of the firmware program in the controller in order to match different flash memories following continuous development of new and fast flash memories.

### SUMMARY OF THE INVENTION

Accordingly, the present invention is directed to a flash memory information reading/writing method allows reading of a new flash memory information from an external host or memory, and writing of the new flash memory information in a predetermined address in the flash memory module of the flash memory device so that the flash memory device can give up the original manufacture data of the flash memory device for normal operation when the original flash memory information is in error or damaged.

The present invention provides a flash memory information reading/writing method for updating flash memory information of a flash memory device. The method comprises: determining whether the flash memory information of the flash memory device can be correctly read and recognized; terminating the updating if the flash memory information of the flash memory device can be correctly read and recognized; reading new flash memory information from an external resource if the flash memory information of the flash memory device can not be correctly read and recognized; and writing the new flash memory information in a predetermined address in a flash memory module of the flash memory device.

In an embodiment of the present invention, the external resource includes a host, an external controller, an electronically erasable programmable read only memory, or a flash memory.

In an embodiment of the present invention, when the external resource is a host, the host provides the new flash memory information through one of a built-in program and an external program.

In an embodiment of the present invention, the flash memory device comprises a host transmission interface.

In an embodiment of the present invention, the host transmission interface includes Universal Series Bus (USB), IEEE 1394, Peripheral Component Interconnection Express (PCIe) or Serial Advanced Technology Attachment (SATA).

In an embodiment of the present invention, the host transmission interface includes Integrated Drive Electronics (IDE), Personal Computer Memory Card International Association (PCMCIA) or Advanced Technology Attachment (ATA).

In an embodiment of the present invention, the flash memory device is one of mobile memory stick (MS), Secure Digital (SD) memory card, Multi Media Card (MMC) memory card, SATA hard disk and PCI Express memory card.

The present invention provides a flash memory information reading/writing method for updating default flash memory information in a controller of a flash memory device. The method comprises: reading flash information of the flash memory device; comparing the flash memory information of the flash memory device with the default flash memory information stored in the controller; terminating the updating if the flash memory information of the flash memory device match the default flash memory information stored in the controller; and reading new flash memory information form a predetermined address in a flash memory module of the flash memory device if the flash memory information of the flash memory device can not match the default flash memory information stored in the controller.

In an embodiment of the present invention, the flash memory device is one of mobile memory stick (MS), SD memory card, MMC memory card, SATA hard disk and PCI Express memory card.

The present invention provides a storage device. The device comprises a controller for controlling an operation of the storage device, a host transmission interface for transmitting data between the storage device and an external source, and a flash memory module for storing data. The controller can determine whether flash memory information of the flash memory module can be correctly read and recognized. The controller can read new flash memory information from the external resource if the controller can not be correctly read and recognized the flash memory information of the flash memory module. The controller can write the new flash memory information in a predetermined address in the flash memory module.

In an embodiment of the present invention, the controller can read the flash information of the flash memory module and compare the flash memory information with a default flash memory information stored in the controller, and the controller can read the new flash memory information from the predetermined address in the flash memory module if the flash memory information of the flash memory module can not match the default flash memory information stored in the controller.

In an embodiment of the present invention, the device further comprises an electronically erasable programmable read only memory for storing the new flash memory information.

In an embodiment of the present invention, the external resource includes a host, an external controller, an electronically erasable programmable read only memory, or a flash memory.

In an embodiment of the present invention, when the external resource is a host, the host provides the new flash memory information through one of a built-in program and an external program.

In an embodiment of the present invention, the host transmission interface includes USB, IEEE 1394, PCI Express or SATA.

In an embodiment of the present invention, the host transmission interface includes IDE, PCMCIA or ATA.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a system block diagram of a flash memory device according to the present invention.

FIG. 2 is a system block diagram of an alternate form of the flash memory device according to the present invention.

FIG. 3 is a flow chart illustrating a flash memory information reading/writing method according to a first embodiment of the present invention.

FIG. 4 is a flow chart illustrating a flash memory information reading/writing method according to a second embodiment of the present invention.

FIG. 5 is a circuit diagram of a controller for flash memory device according to the present invention.

FIG. 6 is a circuit diagram of a flash memory module for flash memory device according to the present invention.

FIG. 7 is a circuit diagram of a host transmission interface for flash memory device according to the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

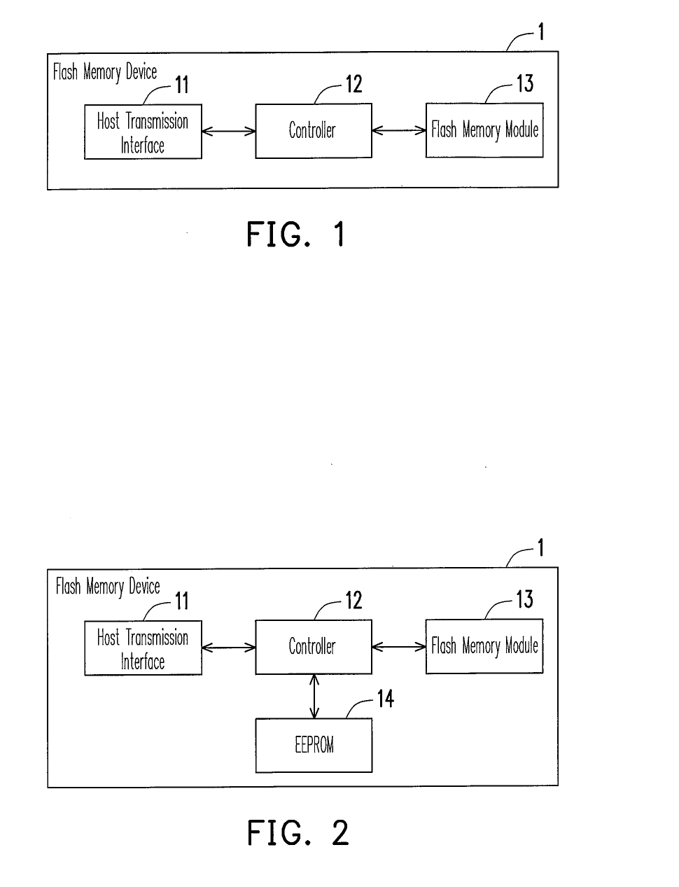

Referring to FIG. 1, a flash memory device 1 (i.e., a storage device) includes a host transmission interface 11, a controller 12, and a flash memory module 13.

The host transmission interface 11 is used for a transmission of data between the flash memory device 1 and an external host.

The controller 12 is electrically connected to the hot transmission interface 11, and adapted to control a reading/writing operation of the flash memory device 1.

The flash memory module 13 is an integrated circuit with memory function, and electrically connected to the controller 12. Further, the flash memory module 13 can be comprised of multiple flash memory chips.

FIG. 2 is a system block diagram of an alternate form of the flash memory device according to the present invention. This embodiment is substantially similar to the aforesaid first embodiment shown in FIG. 1 with the exception of the added EEPROM 14. The EEPROM 14 is electrically connected to the controller 12. In addition to the advantages of a non-volatile memory, the EEPROM 14 has the advantages of a volatile memory of read/write repeatability, high read/write speed, and high level of integration.

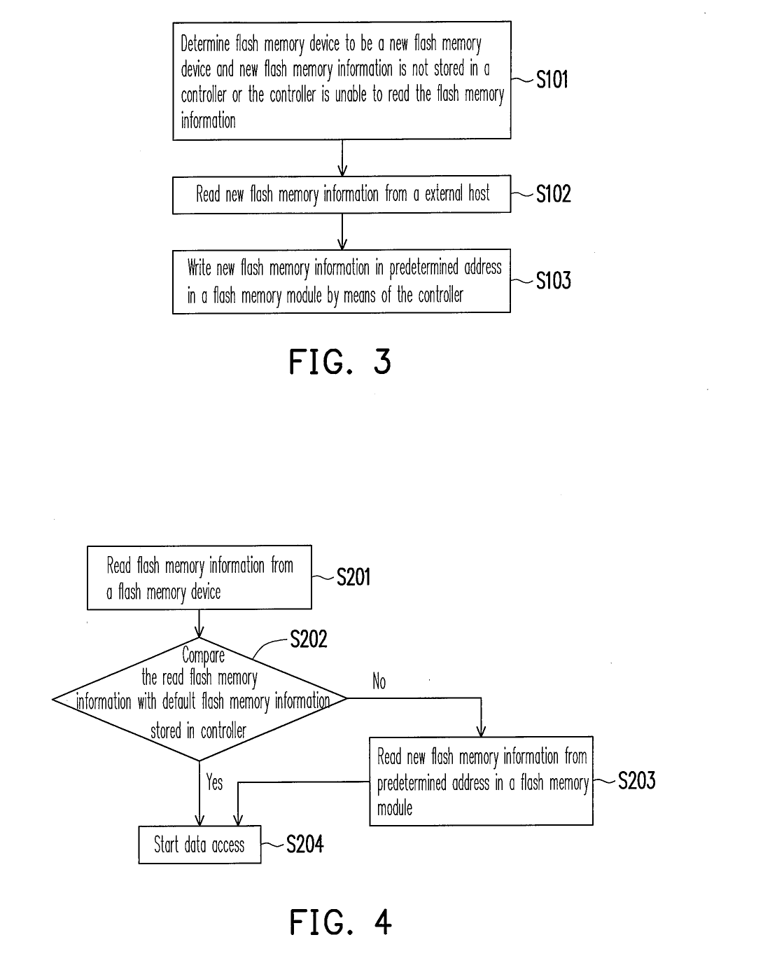

FIG. 3 is a flow chart illustrating a flash memory information reading/writing method according to a first embodiment of the present invention. The flash memory information reading/writing method of the present invention allows to re-write new flash memory information (ID) into a flash memory device during its fabrication, or to update the flash memory information. (ID) of a flash memory device when the controller 12 can not read the flash memory information of the flash memory device. Referring to FIG. 3, The flash memory information reading/writing method includes the steps of:

(101) determining whether the flash memory device 1 is a new flash memory device, and whether the flash memory information of the flash memory device 1 is not stored in the controller 12 or the controller 12 is unable to read and recognize the flash memory information, and then proceed to step (102) if the flash memory device 1 is a new flash memory device and the flash memory information is not stored in the controller 12 or the controller 12 is unable to read and recognize the flash memory information, otherwise end the procedure;

(102) reading a new flash memory information from an external resource if the flash memory information of the flash memory device can not be read by the controller, and then proceed to step (103); and

(103) writing the read new flash memory information in a specific address in the flash memory module 13 of the flash memory device 1 through the controller 12.

The aforesaid flash memory information reading/writing method through an external host can be run through a built-in or external program.

FIG. 4 is a flow chart illustrating a flash memory information reading/writing method according to a second embodiment of the present invention. Referring to FIG. 4, after writing of a new flash memory information into the flash memory module 13 of the flash memory device 1, the flash memory device 1 is used subject to the steps of:

(201) reading a flash information of the flash memory device 1, and then proceed to step (202);

(202) comparing the flash memory information with a default flash memory information stored in the controller 12, and then proceed to step (204) when matched, or step (203) when not matched;

(203) reading a new flash memory information form a new specific address in the flash memory module 13 of the flash memory device 1 by the controller 12, and then proceed to step (204); and

(204) start data access.

Further, except the way of reading new flash memory information from a predetermined host, new flash memory information can be fetched from an external EEPROM, external flash memory, or external controller, i.e., new flash memory information can be fetched from any of a variety of external resources. Further, the aforesaid host transmission interface 11 can be Universal Series Bus (USB), IEEE 1394 or Serial Advanced Technology Attachment (SATA), or Integrated Drive Electronics (IDE), Personal Computer Memory Card International Association (PCMCIA), Peripheral Component Interconnection Express (PCIe) or Advanced Technology Attachment (ATA). Further, the flash memory device 1 can be a mobile memory stick (MS), Secure Digital (SD) memory card, Multi Media Card (MMC) memory card, SATA hard disk or PCI Express memory card.

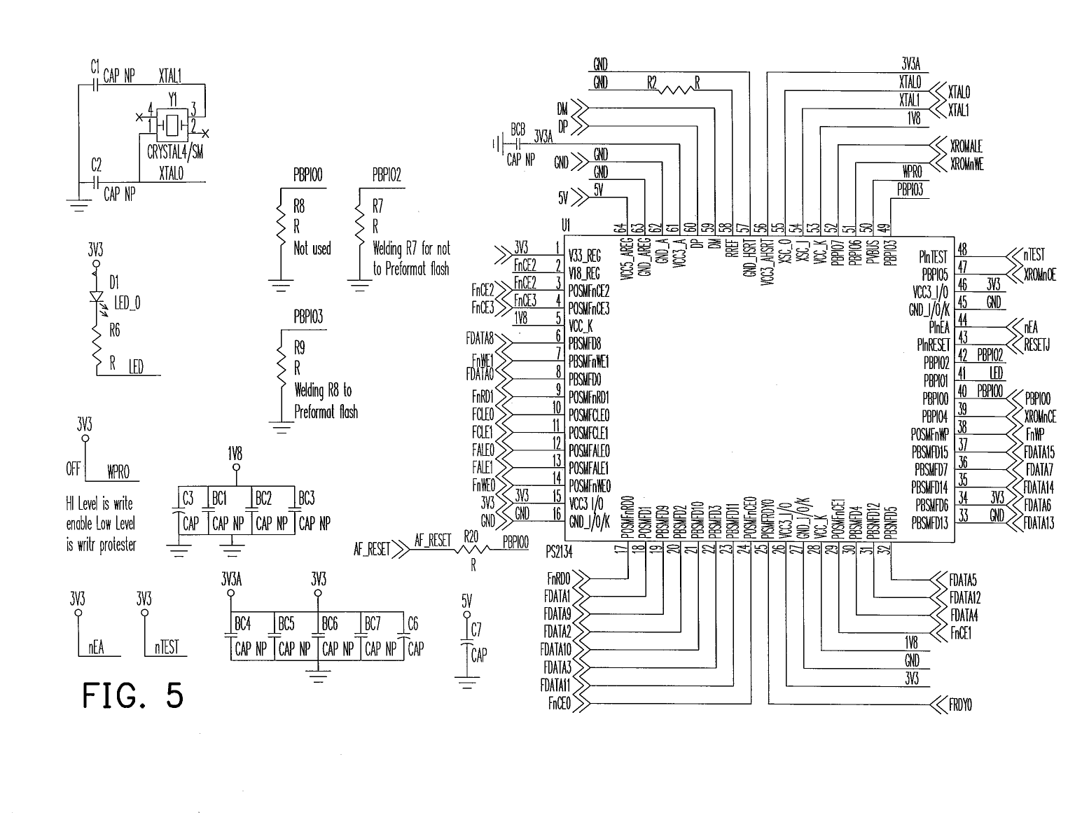

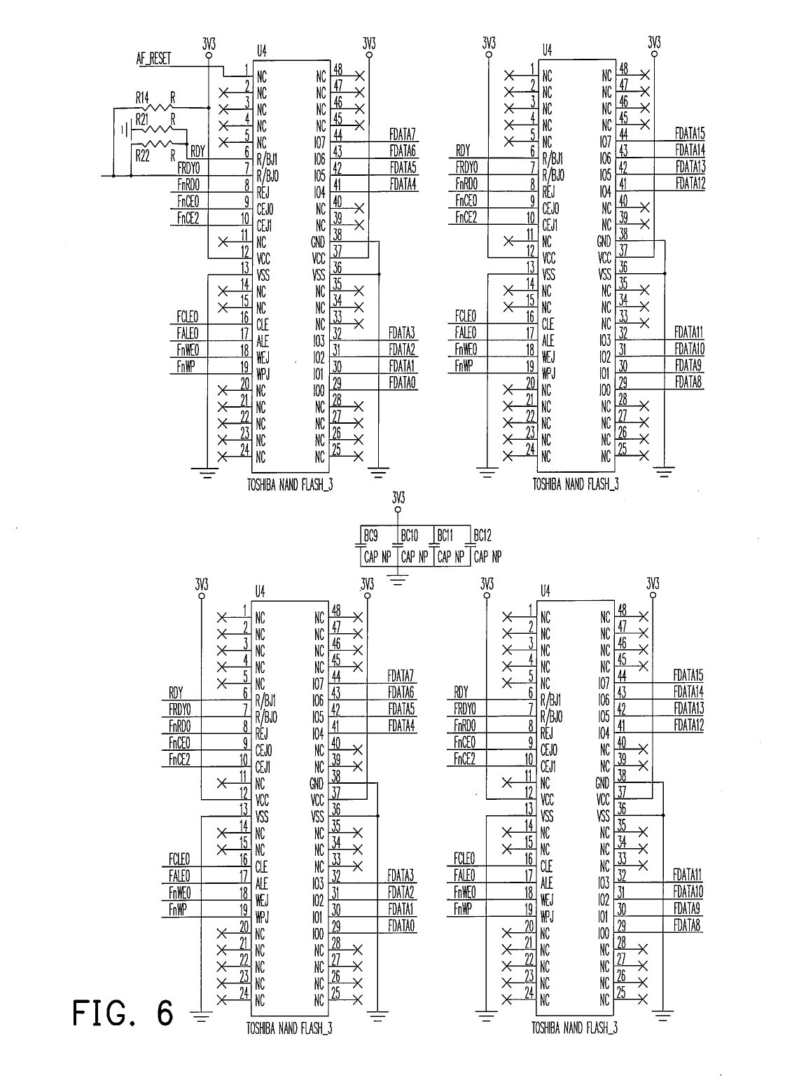

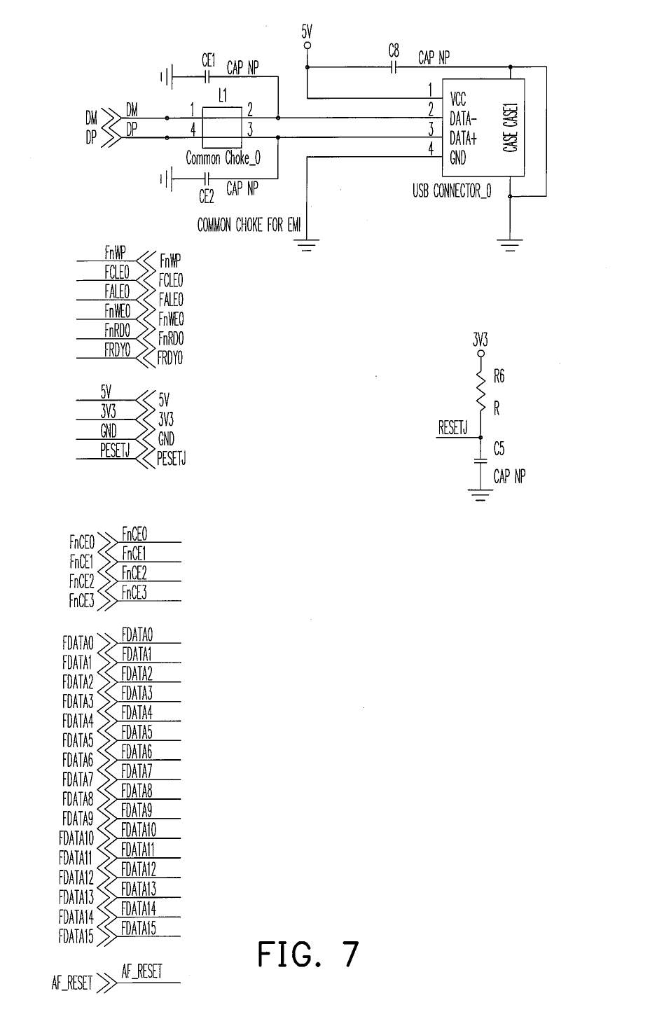

FIGS. 5, 6 and 7 are circuit diagrams of the flash memory device according to the present invention. The controller 12 is a PS2134 chip provided by PHISON. As stated above, the flash memory information read/write method of the present invention has the following features:

The invention allows reading of new flash memory information from an external host or memory means and then writing the fetched new flash memory information in a specific address in the flash memory module 13 of the flash memory device 1. If the flash memory information is in error or damaged, the flash memory device 1 can give up the default manufacturing data and read the new flash memory information from the flash memory module 13, allowing normal use of the flash memory device 1, and increasing the yield rate of the flash memory device fabrication.

When running a flash memory device, it is to read the factory defaults of the flash memory device. If the controller can read this information accurately, the firmware will read and determine the type and size of the flash memory module as designed. However, if the factory information does not match the default values in the controller, the invention allows an external device to update the flash memory information to ensure that the new and old flash memories are compatible.

When the flash memory information of the factory defaults is damaged or to be updated, an external resource can be used to update the original flash memory information. By means of this updating technique, flash memory controller providers need not to provide different firmware controllers subject to different flash memories, thereby saving much firmware controller development cost and simplifying the related chip inventory control.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A flash memory information reading/writing method for updating flash memory information of a flash memory device, comprising:
determining whether the flash memory information of the flash memory device can be correctly read and recognized;
terminating the updating if the flash memory information of the flash memory device can be correctly read and recognized;
reading new flash memory information from an external resource if the flash memory information of the flash memory device can not be correctly read and recognized; and
writing the new flash memory information in a predetermined address in a flash memory module of the flash memory device.

2. The method according to claim 1, wherein the external resource includes a host, an external controller, an electronically erasable programmable read only memory, or a flash memory.

3. The method according to claim 2, wherein the external resource is a host, the host provides the new flash memory information through one of a built-in program and an external program.

4. The method according to claim 1, wherein the flash memory device comprises a host transmission interface.

5. The method according to claim 4, wherein the host transmission interface includes Universal Series Bus (USB), IEEE 1394, Peripheral Component Interconnection Express (PCIe) or Serial Advanced Technology Attachment (SATA).

6. The method according to claim 4, wherein the host transmission interface includes Integrated Drive Electronics (IDE), Personal Computer Memory Card International Association (PCMCIA) or Advanced Technology Attachment (ATA).

7. The method according to claim 1, wherein the flash memory device is one of mobile memory stick (MS), Secure Digital (SD) memory card, Multi Media Card (MMC) memory card, SATA hard disk and PCI Express memory card.

8. A flash memory information reading/writing method for updating default flash memory information in a controller of a flash memory device, comprising:
reading flash information of the flash memory device;
comparing the flash memory information of the flash memory device with the default flash memory information stored in the controller;
terminating the updating if the flash memory information of the flash memory device match the default flash memory information stored in the controller; and
reading new flash memory information form a predetermined address in a flash memory module of the flash memory device if the flash memory information of the flash memory device can not match the default flash memory information stored in the controller.

9. The method according to claim 8, wherein the flash memory device is one of mobile memory stick (MS), SD memory card, MMC memory card, SATA hard disk and PCI Express memory card.

10. A storage device, comprising:
a controller for controlling a operation of the storage device;
a host transmission interface for transmitting data between the storage device and an external source; and
a flash memory module for storing data,
wherein the controller can determine whether flash memory information of the flash memory module can be correctly read and recognized,
wherein the controller can read new flash memory information from the external resource if the controller can not be correctly read and recognized the flash memory information of the flash memory module; and
wherein the controller can write the new flash memory information in a predetermined address in the flash memory module.

11. The storage device according to claim 10,
wherein the controller can read the flash information of the flash memory module and compare the flash memory information with default flash memory information stored in the controller, and
wherein the controller can read the new flash memory information from the predetermined address in the flash memory module if the flash memory information of the flash memory module can not match the default flash memory information stored in the controller.

12. The storage device according to claim 11, further comprising an electronically erasable programmable read only memory for storing the new flash memory information.

13. The storage device according to claim 11, wherein the external resource includes a host, an external controller, an electronically erasable programmable read only memory, or a flash memory.

14. The storage device according to claim 11, wherein the external resource is a host, the host provides the new flash memory information through one of a built-in program and an external program.

15. The storage device according to claim 11, wherein the host transmission interface includes USB, IEEE 1394, PCI Express or SATA.

16. The storage device according to claim 11, wherein the host transmission interface includes IDE, PCMCIA or ATA.
